(19) United States
(12) Patent Application Publication
(10) Pub. No.: US 2025/0245795 A1
(43) Pub. Date: Jul. 31, 2025

(54) AVM calibration method by use of generative artificial intelligence

(71) Applicants: Tae Ho KIM, Seoul (KR); Sang Gu KIM, Seoul (KR); Kang San CHOI, Seoul (KR); Jin Bok KIM, Seongnam-si (KR); In Sub LEE, Seongnam-si (KR)

(72) Inventors: Tae Ho KIM, Seoul (KR); Sang Gu KIM, Seoul (KR); Kang San CHOI, Seoul (KR); Jin Bok KIM, Seongnam-si (KR); In Sub LEE, Seongnam-si (KR)

(21) Appl. No.: 18/951,486

(22) Filed: Nov. 18, 2024

(30) Foreign Application Priority Data
Jan. 31, 2024 (KR) 10-2024-0015398

(51) Int. Cl. G06T 5/80; G06T 5/50; G06T 7/11; G06T 7/80; G06V 10/82; G06V 20/00; G06V 20/58

(52) U.S. Cl. CPC G06T 5/80; G06T 5/50; G06T 7/11; G06T 7/80; G06V 10/82; G06V 20/58; G06V 20/95; G06T 2207/20081; G06T 2207/20084; G06T 2207/30204; G06T 2207/30252

(57) ABSTRACT

The present invention generally relates to a technology that calibrates a camera setting for a vehicle AVM system. In particular, the present invention relates to an AVM calibration technology by use of generative artificial intelligence (AI) that searches for a camera parameter for removing AVM video distortion by performing marker-based data processing on a video imaged by a camera of a vehicle AVM system by use of a generative AI model including a policy network, a value network, and a control network. The present invention is advantageous in that an AVM system can be stably calibrated even without a dedicated calibration facility and skilled personnel. In addition, the present invention is advantageous in that, even in a case where full-automatic-mode calibration fails, AVM calibration can be performed with reduced user intervention compared to that in the related art, by performing semi-automatic-mode AVM calibration using outline information of a marker.

### BACKGROUND OF THE INVENTION

### Field of the Invention

The present invention generally relates to a technology that calibrates a camera setting for a vehicle AVM system.

In particular, the present invention relates to an AVM calibration technology by use of generative artificial intelligence (AI) that searches for a camera parameter for removing AVM video distortion by performing marker-based data processing on a video imaged by a camera of a vehicle AVM system by use of a generative AI model including a policy network, a value network, and a control network.

### Description of the Related Art

Recently, there is a trend to introduce around view monitor (AVM) systems in vehicles. The AVM systems are technologies that image surroundings of a vehicle by cameras attached to the vehicle, then synthesize the videos, and display a synthesized video on an in-vehicle monitor screen. In this case, the AVM systems provide functions of changing a viewpoint and displaying the changed viewpoint so that drivers can effectively recognize situations around corresponding vehicles. The around view monitor (AVM) is also referred to as the surround view monitoring (SVM).

In order to realize a high-quality AVM video while a viewpoint is changed, a position and a posture of a camera installed in a corresponding vehicle and an angle of view and a distortion coefficient of a camera lens need to be accurately measured. In order to accurately measure these parameters, it is necessary to secure a dedicated calibration facility with uniform lighting and skilled personnel and machinery to always bring vehicles in the same position. On vehicle production lines, calibration of tolerances is performed for each vehicle by these items of equipment. For convenience, this is also referred to as ‘factory calibration’.

Incidentally, when a vehicle is actually used, AVM conditions may differ from those at the time of vehicle production due to the number of people in the vehicle, weight of cargo in the vehicle, a change in tire pressure depending on seasons, replacement of parts for vehicle repair, or the like. Accordingly, a camera installation height and orientation point is changed, and the result thereof is deterioration in the quality of an AVM composite screen. In general repair shops or AVM installation shops, AVM calibration is not performed properly due to distortion of marker shapes and outlines depending on lighting environments. In addition, there are technical barriers against identifying and resolving problems, as unskilled personnel carry out calibration processes.

Accordingly, there is a demand for a technology that assists unskilled personnel (vehicle drivers or external engineers) in calibrating AVM systems in common lighting environments.

### SUMMARY OF THE INVENTION

An object of the present invention is generally to provide a technology that calibrates a camera setting for a vehicle AVM system.

In particular, the object of the present invention is to provide an AVM calibration technology by use of generative artificial intelligence (AI) that searches for a camera parameter for removing AVM video distortion by performing marker-based data processing on a video imaged by a camera of a vehicle AVM system by use of a generative AI model including a policy network, a value network, and a control network.

To achieve the object, the present invention proposes a method for performing AVM calibration by use of a generative AI model by a computer device.

An AVM calibration method by use of generative artificial intelligence according to the present invention may include: acquiring a camera image for an AVM video in a calibration facility space where markers are installed; initializing a camera parameter Z for AVM video generation; initially forming a marker candidate group by extracting a plurality of marker candidate images through outline-based image analysis of the camera image for each marker; performing full-automatic-mode AVM calibration based on marker outlines for the marker candidate group by use of the generative AI model; performing semi-automatic-mode AVM calibration on the marker candidate group by use of the generative AI model; and performing neural network learning of the value networks and the control network by utilizing KL divergence for outputs of the policy networks and outputs of the value networks.

A computer program according to the present invention is stored in a non-volatile computer-readable storage medium to execute the AVM calibration method by use of generative artificial intelligence described above on a computer.

### BRIEF DESCRIPTION OF THE DRAWINGS

FIG. 1 is a conceptual diagram of general marker-based AVM calibration.

FIG. 2 is a flowchart of a general marker-based AVM calibration process.

FIG. 3 is a flowchart of an overall AVM calibration process by use of generative artificial intelligence according to the present invention.

FIG. 4 is a flowchart of full-automatic-mode AVM calibration process according to the present invention.

FIG. 5 is a flowchart of semi-automatic-mode AVM calibration process according to the present invention.

FIG. 6 is a configuration diagram of a generative AI model for AVM calibration in the present invention.

FIG. 7 is a configuration diagram of a policy network, a value network, and a control network in the present invention.

FIG. 8 is a conceptual diagram illustrating a relationship between full-automatic-mode AVM calibration and semi-automatic-mode AVM calibration.

FIG. 9 is an illustrative view of view mode selection and marker selection for the semi-automatic-mode AVM calibration in the present invention.

FIG. 10 is an illustrative view of view mode selection and marker selection for the semi-automatic-mode AVM calibration in the present invention.

### DESCRIPTION OF THE PREFERRED EMBODIMENTS

Hereinafter, the present invention will be described with reference to the drawings.

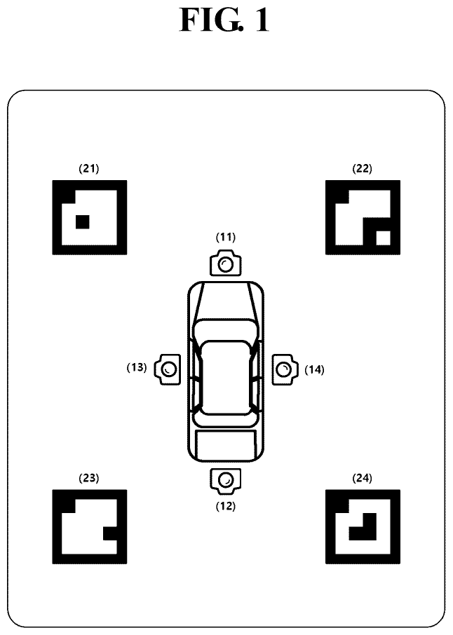

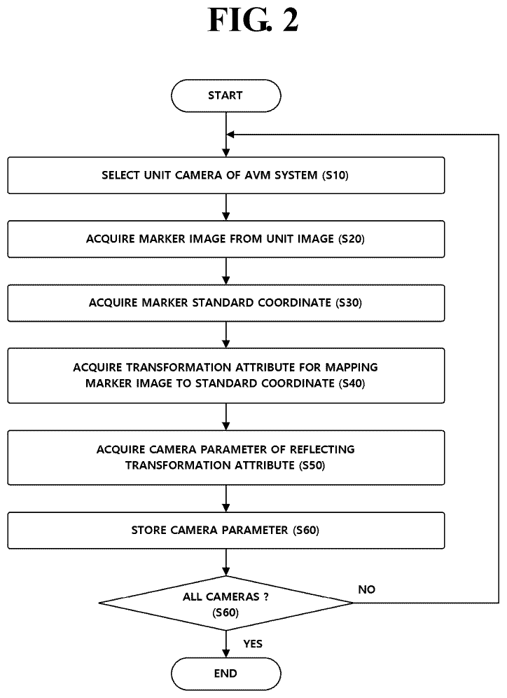

FIG. 1 is a conceptual diagram of general marker-based AVM calibration, and FIG. 2 is a flowchart of a general marker-based AVM calibration process.

A vehicle is brought in a calibration facility (calibration workspace), markers 21 to 24 around the vehicle are imaged by a plurality of unit cameras 11 to 14 mounted on the vehicle, and information for calibrating distortion of the marker images is obtained. For example, a process of extracting marker images by using a computer vision technique and transforming the marker images into standard shapes is performed. A camera parameter obtained during this marker transforming process is saved for each camera, and then a good AVM video can be obtained by applying the stored camera parameter to a video obtained by each camera in a state where the AVM system needs to operate later.

In the present invention, the markers 21 to 24 are marks used for object recognition and coordinate recognition in the field of computer vision and can be realized as a QR code or an image pattern. As illustrated in FIG. 1, the markers 21 to 24 are arranged near respective corners of the vehicle.

For AVM calibration, a computer device (e.g., the AVM system) sequentially selects the unit cameras 11 to 14 (S10) and acquires marker images from unit images (S20). The marker images included in the unit images are each slightly distorted from a standard marker shape (e.g., a square). Hence, a camera parameter that can compensate for a video distortion characteristic inherent in each of the unit cameras 11 to 14 is obtained from the marker image and stored.

In this respect, a marker standard coordinate depending on the standard marker shape is obtained (S30), and a transformation attribute for mapping the marker image at a standard coordinate is obtained (S40). In this respect, actual coordinate values are obtained for several points (e.g., corners) of the marker image appearing in the unit image. Since the coordinate values before and after transformation for the several points are known, the transformation attribute (e.g., a transformation matrix) for mapping an actual coordinate value of the marker image to the marker standard coordinate can be acquired. Obtaining of the transformation attribute when coordinate values before and after transformation are given is widely known in the field of machine vision, and thus the description thereof is not provided in detail. Since this transformation attribute (e.g., a transformation matrix) is information for enabling a video distortion characteristic inherent in the unit camera to be removed, a camera parameter for the unit camera is obtained by reflecting this transformation attribute (S50) and stored (S60).

The above-described process is performed for the plurality of unit cameras 11 to 14 constituting the AVM system.

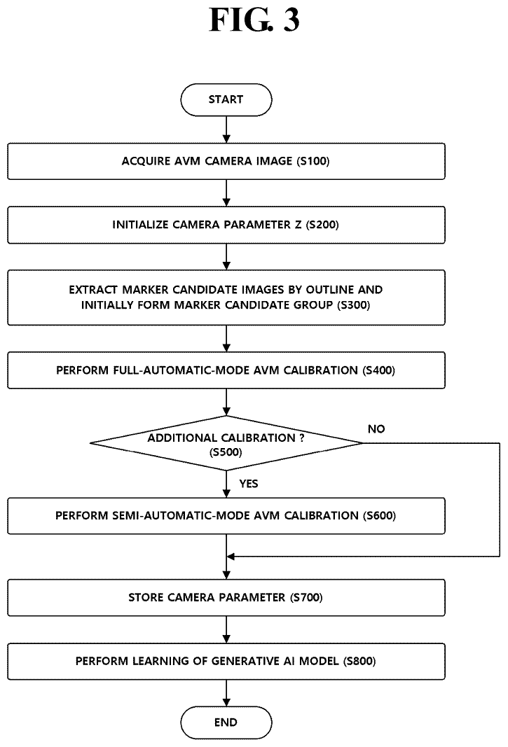

FIG. 3 is a flowchart of an overall AVM calibration process by use of generative artificial intelligence according to the present invention.

In the present invention, the AVM calibration is generally a process of obtaining a camera parameter for transforming an AVM camera image into an AVM video without distortion after bringing a vehicle in a calibration facility and imaging a standard marker marked on a floor of the calibration facility by an AVM camera. In the present invention, the computer device obtains a camera parameter for removing AVM video distortion based on a generative AI model. In this case, the computer device may be an AVM system control device mounted on the vehicle or an external computer (e.g., a laptop computer or a dedicated computer) carried with a user.

Hereinafter, a process of performing AVM calibration by using the generative AI model will be specifically described.

Steps (S100, S200): First, the computer device (e.g., the AVM system) acquires a camera images for an AVM video in a state where the vehicle is brought in the calibration facility space where the markers 21 to 24 are arranged.

In addition, camera parameters Z for AVM video generation are initialized. An initial value Z0 of the camera parameter Z can be set to a pre-stored standard value according to vehicle specifications (e.g., a model name, a model year, or the like). The camera parameters Z generally include extrinsic parameters and intrinsic parameters. The extrinsic parameters are information indicating camera posture information and include camera installation location information (e.g., spatial coordinate values x, y, and z) and camera posture information (e.g., yaw, pitch, and roll). The intrinsic parameters are information indicating characteristics of a camera lens. In general, values that are stored in advance in an AVM manufacturing process are used as the intrinsic parameters, and actual measured values may also be used depending on implementations.

Step (S300): Next, a marker candidate group is initially formed by extracting a plurality of marker candidate images through outline-based image analysis of the camera image for each marker. For example, in the case of FIG. 1, image analysis for the camera images is performed to form four marker candidate groups including such as, 100, 105, 98, and 75 marker candidate images, respectively, for the four markers 21 to 24 or the four cameras 11 to 14.

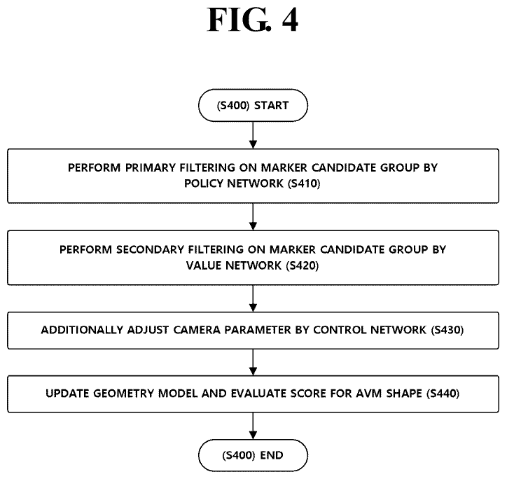

Step (S400): Next, full-automatic-mode AVM calibration based on marker outlines is performed for the marker candidate groups by use of the generative AI model. FIG. 4 is a flowchart of full-automatic-mode AVM calibration process according to the present invention. In the full-automatic-mode AVM calibration process, good marker candidate images are to be obtained by repeatedly filtering the marker candidate groups by the generative AI model, and the camera parameters Z are to be adjusted to further remove AVM video distortion.

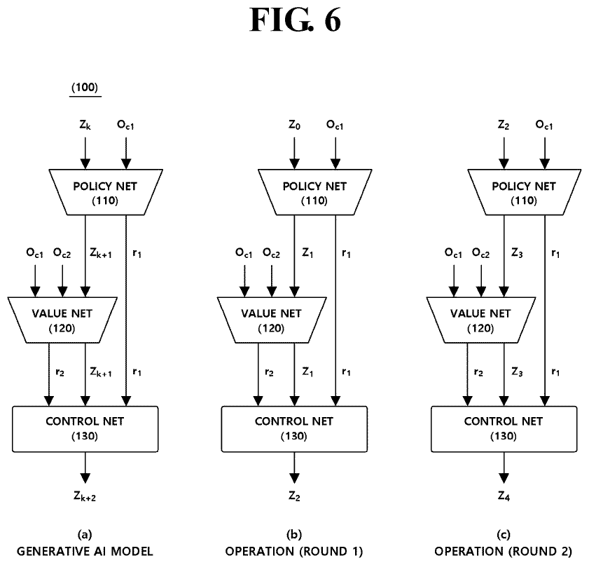

FIG. 6 is a configuration diagram of a generative AI model 100 for AVM calibration in the present invention.

With reference to FIG. 6 (a), the generative AI model 100 for the present invention includes a policy network 110, a value network 120, and a control network 130. The generative AI model 100 of the present invention can be understood by referring to the World Model proposed by David Ha and Jurgen Schmidhuber (refer to https://worldmodels.github.io/).

The policy network 110 performs primary filtering on the marker candidate groups with the individual marker candidate images as references depending on a current camera parameter Zₖ and an MLP neural network, and calculates an intermediate camera parameter Zₖ₊₁ and an individual marker probability values r₁.

The value network 120 performs secondary filtering on the marker candidate groups with the marker candidate images (hereinafter referred to as “common marker candidate images”) as references, which overlap each other in a common region of adjacent cameras, depending on the intermediate camera parameter Zₖ₊₁ and a CNN neural network, and calculates a common marker probability values r₂.

The control network 130 calculates an auto-adjustment camera parameter Zₖ₊₂ by inputting the intermediate camera parameter Zₖ₊₁, the individual marker probability values r₁, and the common marker probability values r₂ into an MDN-RNN neural network. The MDN-RNN neural network improves a convergence speed of the AVM calibration by adjusting the camera parameters Z.

Hereinafter, operations of the policy network 110, the value network 120, and the control network 130 will be described in detail.

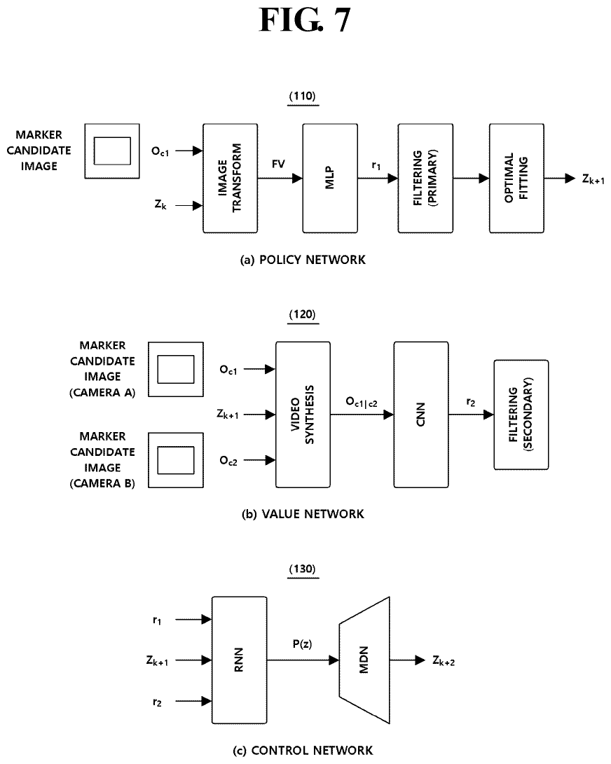

First, the operations of the policy network 110 will be described with reference to FIG. 7 (a).

The policy network 110 receives the current camera parameter Zₖ and the marker candidate groups, calculates the marker probability values r₁ (‘individual marker probability value’) of individual marker candidate images O_{c1} by the MLP neural network, and then performs primary filtering on the marker candidate groups with the individual marker probability values r₁ as a reference. Then, the policy network 110 calculates the intermediate camera parameters Zₖ₊₁ for providing optimal fitting for the marker candidate images in the marker candidate groups remaining after the primary filtering.

Specifically, the marker candidate images O_{c1} belonging to the marker candidate groups are transformed into images based on the current camera parameter Zₖ, and a feature vector (e.g., a size, a shape, or the like) is extracted for each of the transformed marker candidate images O_{c1}′.

The probability r₁ (0 to 1) that a corresponding marker candidate image O_{c1} is a marker image is calculated by inputting the feature vector extracted for each of a plurality of marker candidate images O_{c1} into a multi-layer perceptron (MLP) neural network. For convenience, the probability is referred to as the ‘individual marker probability values r₁’ in this specification. The policy network 110 calculates individual marker probability values r₁ for the plurality of marker candidate images O_{c1} belonging to the marker candidate groups, and then performs filtering on the marker candidate groups based on the individual marker probability values r₁. That is, the marker candidate images O_{c1} having the individual marker probability values r₁ lower than a threshold are excluded from the marker candidate groups. For convenience, this filtering is referred to as the ‘primary filtering’ in this specification. By this primary filtering, the size of a marker candidate group is reduced (e.g., 70 marker candidate images).

Then, for the marker candidate group which has the reduced size, the camera parameter Zₖ₊₁ for optimally fitting the marker candidate images to a standard marker shape is obtained. As an example, the optimal fitting is a process of finding a camera parameter indicating a minimum error (e.g., Least Square Error) from the standard marker shape in the case of transforming the marker candidate images O_{c1} belonging to the marker candidate groups. In this case, the camera parameter Zₖ₊₁ output by the policy network 110 is referred to as the ‘intermediate camera parameter Zₖ₊₁’ for convenience.

Next, the operations of the value network 120 will be described with reference to FIG. 7 (b).

The value network 120 receives the intermediate camera parameter Zₖ₊₁ and the marker candidate groups (that is, the marker candidate groups obtained after the primary filtering), calculates a marker probability values r₂ (‘common marker probability value’) of the common marker candidate images O_{c1} and O_{c2} of the adjacent cameras by the CNN neural network, and then performs secondary filtering on the marker candidate groups with the common marker probability values r₂ as a reference.

The value network 120 receives and uses the marker candidate groups obtained after the primary filtering from the policy network 110. For example, it is assumed that four marker candidate groups including 100, 105, 98, and 75 marker candidate images, respectively, are formed at S300, and that these four marker candidate groups are reduced in size to 50, 61, 43, and 39 marker candidate images, respectively, by the primary filtering of the policy network 110. The value network 120 performs a process by using the four marker candidate groups reduced in size as described above.

In general, since the AVM system uses wide-angle cameras (e.g., a fish-eye lens), adjacent cameras image the same markers in a common region. Hence, the value network 120 applies the intermediate camera parameter Zₖ₊₁ to two marker candidate images O_{c1} and O_{c2} overlapping each other in the common region of adjacent cameras from the marker candidate groups, transforms the marker candidate images into a top view, inputs a synthetic marker candidate image O_{c1|c2} obtained by merging the marker candidate images into a convolutional neural network (CNN), and calculates the probability r₂ (0 to 1) that the synthetic marker candidate image O_{c1|c2} is a marker image. For convenience, the probability r₂ is referred to as the ‘common marker probability values r₂’ in this specification.

The value network 120 finds a plurality of marker candidate image combinations O_{c1} and O_{c2} obtained by imaging the same marker from the marker candidate groups, calculates a common marker probability value r₂ for the marker candidate images, and then performs additional filtering on the marker candidate groups based on the common marker probability value r₂. That is, the marker candidate images O_{c1} and O_{c2} having the common marker probability values r₂ lower than a threshold are excluded from the marker candidate groups. For convenience, this filtering is referred to as the ‘secondary filtering’ in this specification. This secondary filtering reduces a size of a marker candidate group (e.g., 30 marker candidate images).

Next, the operations of the control network 130 will be described with reference to FIG. 7 (c).

The control network 130 receives the intermediate camera parameter Zₖ₊₁, the individual marker probability values r₁, and the common marker probability values r₂ and calculates the auto-adjustment camera parameter Zₖ₊₂.

The intermediate camera parameter Zₖ₊₁ is obtained from a currently selected individual marker candidate image O_{c1}. The individual marker probability values r₁ is a probability value calculated from the currently selected individual marker candidate image O_{c1}, and the common marker probability values r₂ is a probability value calculated from the common marker candidate images O_{c1} and O_{c2} of the adjacent cameras.

The auto-adjustment camera parameter Zₖ₊₂ is obtained by inputting the intermediate camera parameter Zₖ₊₁, the individual marker probability values r₁, and the common marker probability values r₂ into the MDN-RNN neural network.

A recurrent neural network (RNN) is a neural network that processes sequence data and is capable of recognizing and learning patterns inherent in temporally continuous data (time series data). A probability density function P(z) is calculated by inputting the intermediate camera parameter Zₖ₊₁, the individual marker probability values r₁, and the common marker probability values r₂ into the RNN neural network. Then, the auto-adjustment camera parameter Zₖ₊₂ is calculated by inputting the probability density function P(z) into an MDN neural network.

A mixture density network (MDN) is a neural network that performs unsupervised learning and is generally capable of performing data clustering. In particular, the MDN neural network is characterized by outputting parameters of a mixture of Gaussian distributions for effective prediction of a latent vector of the next round. Accordingly, the MDN-RNN (MDN+RNN) neural network is known to be capable of finding optimal values of parameters while predicting variable values of the next round. Hence, in the present invention, the convergence speed of the AVM calibration can be improved by adjusting the camera parameters Z by applying the MDN-RNN.

Next, geometry model update and AVM evaluation operations will be described.

The auto-adjustment camera parameter Zₖ₊₂ obtained in the previous process is applied to the AVM system, and this is referred to as the geometry model update. The AVM videos are synthesized by applying the auto-adjustment camera parameter Zₖ₊₂ to the unit images acquired by the cameras 11 to 14 mounted on the vehicle, and scores for evaluating the generated AVM videos in accordance with a preset criterion are calculated. For example, AVM video outcomes can be scored based on how closely four marker images arranged around the vehicle are restored to standard shapes. The evaluation results of the AVM video correspond to evaluation of distortion removal performance of the auto-adjustment camera parameter Zₖ₊₂.

The evaluation results of the AVM videos can be used to determine whether to further repeat the process of S410 to S430. For example, if the evaluation results of the AVM videos are sufficiently good, it may be determined that there is no need to repeat the process any more. Alternatively, if the evaluation results of the AVM videos are not improved or rather deteriorate even after the process is repeatedly performed several times, it may be determined that there is no need to repeat the process any more.

It is preferable that the procedure of S410 to S440 is configured to perform repeatedly a plurality of times in the full-automatic-mode AVM calibration. In this case, the number of repetitions may be preset or may be determined in S440. FIG. 6 (b) illustrates an operation of the generative AI model 100 in the first round, and FIG. 6 (c) illustrates an operation of the generative AI model 100 in the second round. Outcomes of the first round (that is, a camera parameter Z2 and marker candidate groups obtained after the filtering) are used in the second round. In general, outcomes of the n-th round are used in the (n+1)th round. As the rounds are repeated, inappropriate marker candidate images are removed from the marker candidate groups, and the camera parameters Z are adjusted to further reduce marker image distortion.

In summary, with referring to FIG. 4, the full-automatic-mode AVM calibration process includes performing by the policy network 110 the adjustment of the camera parameters Z and the primary filtering on the marker candidate groups by the MLP neural network with the individual marker candidates as references (S410), performing by the value network 120 the secondary filtering on the marker candidate groups with the common marker candidates of the adjacent cameras as references by the CNN neural network (S420), performing by the control network 130 additional adjustment of the camera parameters Z based on the marker probability values r₁ and r₂ for the marker candidate groups by the MDN-RNN neural network (S430), and updating the geometry model by applying the camera parameters Z which are the results of the adjustment and evaluating the scores for the AVM videos (S440).

Step (S500): Next, whether additional calibration needs to be performed is determined. If it is determined that there is no need to perform the additional calibration, the AVM calibration process according to the present invention is completed by the full-automatic-mode AVM calibration (S300). In a case where the generative AI model 100 is sufficiently trained, the AVM calibration process can be sufficiently performed by the full-automatic-mode AVM calibration (S300). However, if it is determined that the additional calibration needs to be performed, the following semi-automatic-mode AVM calibration (S600) is performed.

For example, if an error value calculated by the policy network 110 in the optimal fitting process is smaller than a preset threshold, it can be determined that there is no need to perform the additional calibration in S500.

In addition, a user can input whether the additional calibration needs to be performed by manipulating a software menu.

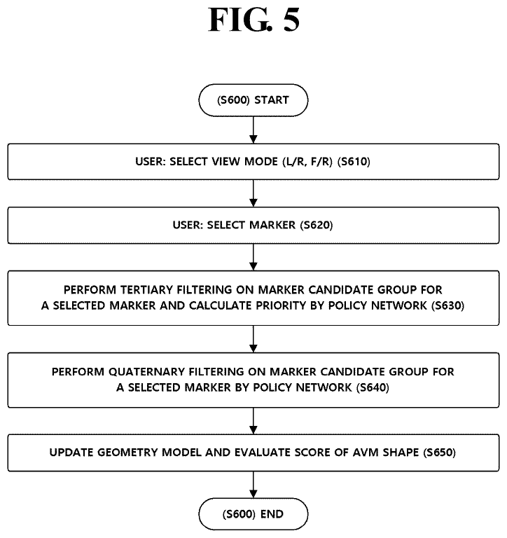

Step (S600): Next, the semi-automatic-mode AVM calibration is performed using the generative AI model. FIG. 5 is a flowchart of semi-automatic-mode AVM calibration process according to the present invention.

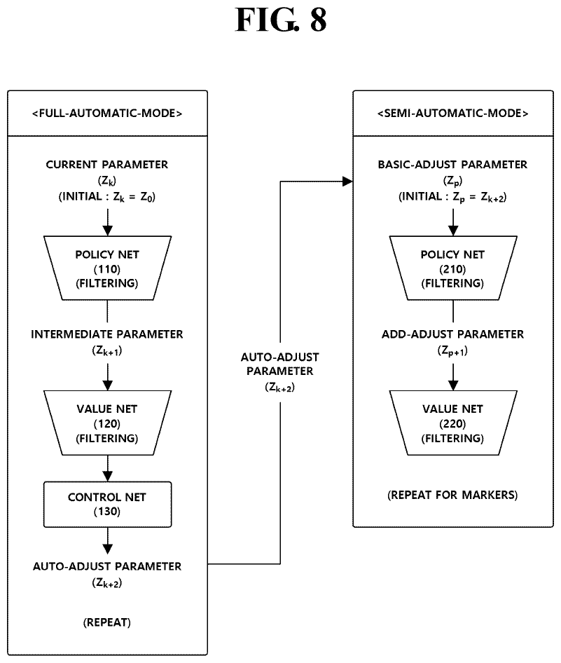

FIG. 8 is a conceptual diagram illustrating a relationship between the full-automatic-mode AVM calibration and the semi-automatic-mode AVM calibration. With reference to FIG. 8, the semi-automatic-mode AVM calibration (S600) is a process of performing additional AVM calibration through user intervention while utilizing the marker candidate groups and the auto-adjustment camera parameter Zₖ₊₂ that are the outcomes of the full-automatic-mode AVM calibration (S400). In the semi-automatic-mode AVM calibration (S600), a policy network 210 and a value network 220 are used.

The policy network 210 receives basic adjustment camera parameters (Zₚ) and marker candidate groups and performs tertiary filtering on the marker candidate groups. Then, the policy network 210 calculates additional adjustment camera parameters Zₚ₊₁ for providing optimal fitting for the marker candidate images remaining in the marker candidate groups obtained after the tertiary filtering. Operations of the policy network 210 are as described above with reference to FIG. 7 (a). In this case, it is preferable that an initial value of the basic adjustment camera parameter Zₚ input to the policy network 210 be set to the auto-adjustment camera parameter Zₖ₊₂ which is the outcome of the full-automatic-mode AVM calibration (S400).

The value network 220 receives the additional adjustment camera parameter Zₚ₊₁ and the marker candidate groups (that is, the marker candidate groups obtained after the tertiary filtering) and performs quaternary filtering on the marker candidate groups. Operations of the value network 220 are as described above with reference to FIG. 5 (b).

In the semi-automatic-mode calibration (S600), the user sequentially selects a plurality of markers, the tertiary filtering of the policy network 210 and the quaternary filtering of the value network 220 are performed on the markers selected by the user, and the camera parameters Z are additionally adjusted (that is, Zₚ₊₁ is calculated from Zₚ).

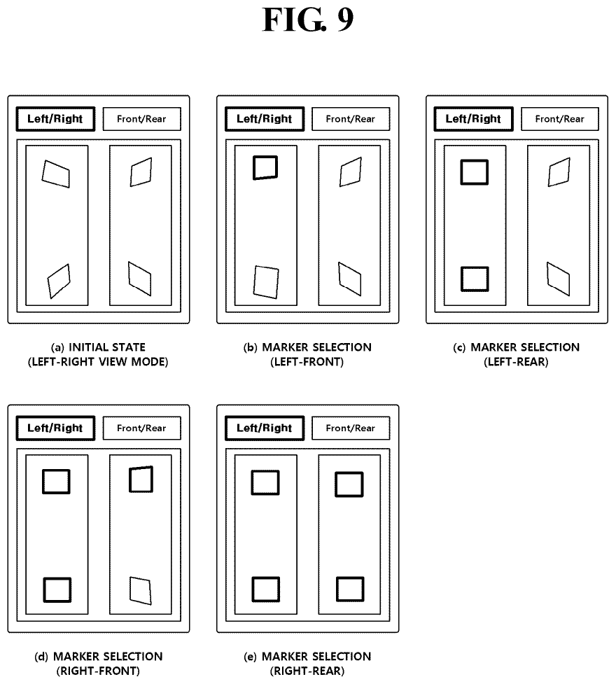

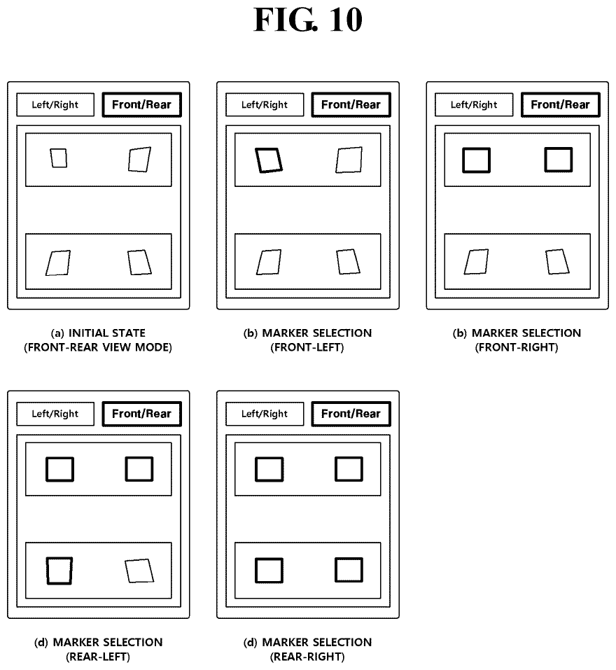

In the semi-automatic-mode AVM calibration (S600), the user's view mode selection and specific marker selection are first identified on an AVM calibration screen (S610 and S620). FIGS. 9 and 10 are illustrative views of the view mode selection and the marker selection for the semi-automatic-mode AVM calibration in the present invention. FIG. 9 is an illustrative view in a case where the user sequentially selects the markers in a state where a left/right view mode is selected, and FIG. 10 is an illustrative view in a case where the user sequentially selects the markers in a state where a front/rear view mode is selected.

The left/right view mode indicates a state in which images captured by a left camera 13 and a right camera 14 installed in the vehicle are displayed on the screen. In FIG. 9, the Left-Front marker 21 and the Left-Rear marker 23 captured by the left camera 13 are displayed on a left side of the AVM calibration screen, and the Right-Front marker 22 and the Right-Rear marker 24 captured by the right camera 14 are displayed on a right side of the screen.

The front/rear view mode indicates a state in which images captured by a front camera 11 and a rear camera 12 installed in the vehicle are displayed on the screen. In FIG. 10, the Front-Left marker 21 and the Front-Right marker 22 captured by the front camera 11 are displayed on an upper side of the AVM calibration screen, and the Rear-Left marker 23 and a Rear-Right marker 24 captured by the rear camera 12 are displayed on a right side of the screen.

As described above, the user can select the left/right view mode and the front/rear view mode. The user selects one marker in a state where a specific view mode is selected, as in FIG. 9 or 10. FIG. 9 (b) illustrates an example in which the user selects the Left-Front marker 21 in the state where the left/right view mode is selected.

When the user selects a specific marker (e.g., the Left-Front marker 21), the policy network 210 calculates a marker candidate priority for the marker candidate groups of the selected marker (‘selected marker’) (S630). In this respect, the policy network 210 transforms individual marker candidate images O_{c1} belonging to a marker candidate group of the selected marker into images based on the basic adjustment camera parameter Zₚ, extracts a feature vector (e.g., a size, a shape, or the like) for each of the transformed marker candidate images O_{c1}′, and calculates an individual marker probability values r₃ by the MLP neural network. Then, the tertiary filtering is performed on the marker candidate group based on the individual marker probability values r₃. Then, the marker candidate images O_{c1} are prioritized based on the individual marker probability values r₃ for the marker candidate group obtained after the tertiary filtering.

On the AVM calibration screen, the marker candidate images O_{c1} with the highest priority is distinctly displayed on the screen. In FIGS. 9 and 10, the marker candidate images O_{c1} with the highest priority is highlighted with a red line.

Then, the policy network 210 obtains, for the marker candidate group having the size reduced by the tertiary filtering, the additional adjustment camera parameter Zₚ₊₁ for optimally fitting the marker candidate images to the standard marker shape.

Next, the value network 220 receives the additional adjustment camera parameter Zₚ₊₁ and the marker candidate group (that is, the marker candidate group obtained after the tertiary filtering), calculates a common marker probability values r₄ of the common marker candidate images O_{c1} and O_{c2} of the adjacent cameras for the selected marker by the CNN neural network, and then performs the quaternary filtering on a marker candidate group of the selected marker with the common marker probability values r₄ as a reference (S640).

Next, the additional adjustment camera parameter Zₚ₊₁ obtained in the previous process is applied to the cameras 11 to 14 related to the selected marker in the AVM system, and this is referred to as the geometry model update. The AVM videos are synthesized by applying the additional adjustment camera parameter Zₚ₊₁, and scores for evaluating the generated AVM videos in accordance with a preset criterion are calculated (S650). The evaluation results of the AVM videos can be used to determine whether to further repeat the process of S630 and S640. Alternatively, the evaluation results of the AVM videos can be displayed on the AVM calibration video screen to be used to assist the user in making determination.

The above-described processes S610 to S650 are performed for a series of markers as shown in FIGS. 9 and 10. There is no need to perform the above-described processes for all the view modes and all the markers, and the processes are performed depending on the user's selection.

Step (S700): The camera parameters Z acquired through the above-described processes are stored in the AVM system. Preferably, the camera parameters Z are individually acquired for each of the plurality of unit cameras 11 to 14 mounted on the vehicle and are stored in the AVM system. Then, in a situation where the AVM system needs to operate, good AVM videos can be obtained by applying the stored camera parameters Z to the unit imaged videos obtained by the individual cameras 11 to 14.

Step (S800): When AVM calibration data is sufficiently accumulated, neural network learning of the generative AI model 100 is performed.

In the present invention, the neural network learning of the generative AI model 100 can be performed using, as reward values, the evaluation scores S440 and S650 for the geometry model of the AVM system. In this case, the neural network learning of the generative AI model 100 can be performed in a simulation environment.

As in Equation 1, KL divergence for the outputs of the policy networks 110 and 210 and the outputs of the value networks 120 and 220 is utilized in the neural network learning. The KL divergence (Kullback-Leibler divergence) generally indicates how much a predicted value is different from a distribution chart of reference values, and is used as an indicator of a degree of inefficiency of the predicted value with respect to an actual value. The KL divergence is also referred to as relative entropy.

$${D}_{kl} ( {P}_{policy} ‖ {P}_{value} ) \qquad [ Equation 1 ]$$

In this case, the neural network learning of the value networks 120 and 220 can be performed using data obtained by merging an output value of the CNN neural network and a result of the simulation environment.

In addition, the neural network learning of the control network 130 can be performed using, as reward values (r₁, r₂) (r₃, r₄), the individual marker probability values r₁ and r₃ calculated by the policy networks 110 and 210 and the common marker probability values r₂ and r₄ calculated by the value networks 120 and 220.

In the present invention, it can be said that the concept of the generative artificial intelligence is applied to the present invention in that the training data for the neural network learning is not given in a supervised learning manner, but rather an optimal search path found in a reinforcement learning manner by feeding back the network outputs as inputs is learned and utilized in the RNN neural network. A calibration strategy optimized for various environments is not directly coded by a person, but is found by a reinforcement learning method.

Meanwhile, the present invention can be realized in a form of a computer-readable code in a non-volatile computer-readable recording medium. Various types of storage devices are used as the non-volatile recording medium, and examples thereof include a hard disk, an SSD, a CD-ROM, a NAS, a magnetic tape, a web disk, or a cloud disk. In addition, the present invention may be realized in a form of a computer program stored in a medium to execute a specific procedure in combination with hardware.

The present invention is advantageous in that an AVM system can be stably calibrated even without a dedicated calibration facility and skilled personnel.

In addition, the present invention is advantageous in that, even in a case where full-automatic-mode calibration fails, AVM calibration can be performed with reduced user intervention compared to that in the related art, by performing semi-automatic-mode AVM calibration using outline information of a marker.

While the present invention has been described with respect to the specific embodiments, it will be apparent to those skilled in the art that various changes and modifications may be made without departing from the spirit and scope of the invention as defined in the following claims.

What is claimed is:

1. An AVM calibration method by use of generative artificial intelligence by a computer device, comprising:
acquiring a camera image for an AVM video in a calibration facility space where markers are installed;
initializing a camera parameter (Z) for AVM video generation;
initially forming a marker candidate group by extracting a plurality of marker candidate images through outline-based image analysis of the camera image for each marker; and
performing full-automatic-mode AVM calibration based on marker outlines for the marker candidate group by use of the generative AI model,
wherein the performing full-automatic-mode AVM calibration includes:
performing, by a policy network, adjustment of a camera parameter (Z) and primary filtering on the marker candidate group by a multilayer perceptron (MLP) neural network with individual marker candidate images as references;
performing, by a value network, secondary filtering on the marker candidate group by a convolutional neural network (CNN) with marker candidate images (hereinafter referred to as ‘common marker candidate image’) overlapping each other in a common region of adjacent cameras as references; and
performing, by a control network, additional adjustment of the camera parameter (Z) based on a marker probability value for the marker candidate group by an MDN-RNN neural network.

2. The AVM calibration method of claim 1, wherein the performing adjustment of a camera parameter (Z) and primary filtering on the marker candidate group includes:
receiving, by the policy network, a current camera parameter (Zₖ) and the marker candidate group;
transforming, by the policy network, individual marker candidate images (O_{c1}) belonging to the marker candidate group into images based on the current camera parameter (Zₖ);
extracting, by the policy network, a feature vector for each of the transformed marker candidate images (O_{c1}′);
calculating, by the policy network, a probability (r₁) (hereinafter referred to as an ‘individual marker probability value (r₁)’) that a corresponding marker candidate image (O_{c1}) is a marker image by inputting the feature vector into the MLP neural network;
performing, by the policy network, the primary filtering on the marker candidate group based on the individual marker probability value (r₁); and
calculating, by the policy network, an intermediate camera parameter (Zₖ₊₁) that optimally fits the marker candidate images to a standard marker shape for the marker candidate group obtained after the primary filtering.

3. The AVM calibration method of claim 2, wherein the performing secondary filtering on the marker candidate group includes:
receiving, by the value network, the intermediate camera parameter (Zₖ₊₁) and the marker candidate group obtained after the primary filtering;
applying, by the value network, the intermediate camera parameter (Zₖ₊₁) to the marker candidate images (O_{c1} and O_{c2}) overlapping each other in the common region of the adjacent cameras from the marker candidate group;
calculating, by the value network, a probability (r₂) (hereinafter referred to as ‘common marker probability value (r₂)’) that a synthetic marker candidate image (O_{c1|c2}) obtained by merging the transformed marker candidate images (O_{c1} and O_{c2}) is a marker image by inputting the synthetic marker candidate image (O_{c1|c2}) into the CNN neural network; and
performing, by the value network, secondary filtering on the marker candidate group based on the common marker probability value (r₂).

4. The AVM calibration method of claim 3, wherein the performing additional adjustment of the camera parameter (Z) includes:
receiving, by the control network, the intermediate camera parameter (Zₖ₊₁), the individual marker probability value (r₁), and the common marker probability value (r₂);
calculating, by the control network, a probability density function (P(z)) by inputting the intermediate camera parameter (Zₖ₊₁), the individual marker probability value (r₁), and the common marker probability value (r₂) into a recurrent neural network (RNN); and
calculating, by the control network, an auto-adjustment camera parameter (Zₖ₊₂) by inputting the probability density function P(z) into a mixture density neural network (MDN).

5. The AVM calibration method of claim 4, wherein the performing full-automatic-mode AVM calibration further includes:
updating a geometry model by applying the auto-adjustment camera parameter (Zₖ₊₂) to an AVM system, synthesizing AVM videos, and evaluating the AVM videos in accordance with a preset criterion; and
determining, in response to an evaluation result of the AVM videos, whether to repeat the performing full-automatic-mode AVM calibration based on marker outlines for the marker candidate group by use of the generative AI model.

6. The AVM calibration method of claim 4, wherein the method further comprising:
performing semi-automatic-mode AVM calibration on the marker candidate group by use of the generative AI model in a plurality of times for a plurality of markers,
wherein the performing semi-automatic-mode AVM calibration includes:
identifying a user's view mode selection and specific marker selection on an AVM calibration screen;
setting, by a policy network, an initial value of a basic adjustment camera parameter (Zₚ) for the semi-automatic-mode AVM calibration to the auto-adjustment camera parameter (Zₖ₊₂);
transforming, by the policy network, each of the marker candidate images (O_{c1}) belonging to the marker candidate group of the selected marker (hereinafter referred to as a ‘selected marker’) into an image based on the basic adjustment camera parameter (Zₚ) and calculating, by the MLP neural network, a probability (r₃) (hereinafter referred to as an ‘individual marker probability value (r₃)’) that the corresponding marker candidate image (O_{c1}) is a marker image;
calculating, the policy network, a marker candidate priority based on the individual marker probability value (r₃) and performing tertiary filtering on a marker candidate group of the selected marker;
calculating, by the policy network, an additional adjustment camera parameter (Zₚ₊₁) for providing optimal fitting for the marker candidate group obtained after the tertiary filtering;
receiving, by a value network, the additional adjustment camera parameter (Zₚ₊₁) and the marker candidate group obtained after the tertiary filtering;
applying, by the value network, the additional adjustment camera parameter (Zₚ₊₁) to the common marker candidate images (O_{c1} and O_{c2}) of the adjacent cameras for the selected marker from the marker candidate group obtained after the tertiary filtering;
calculating, by the value network, a probability (r₄) (hereinafter referred to as a ‘common marker probability value (r₄)’) that the synthetic marker candidate image (O_{c1|c2}) obtained by merging the transformed marker candidate images (O_{c1} and O_{c2}) is a marker image by inputting the synthetic marker candidate image (O_{c1|c2}) into the CNN neural network; and
performing, by the value network, quaternary filtering on a marker candidate group of the selected marker based on the common marker probability value (r₄).

7. The AVM calibration method of claim 6, wherein the method further comprising:
performing neural network learning of the value networks and the control network by utilizing KL divergence for outputs of the policy networks and outputs of the value networks.

8. A non-transitory computer program contained in a non-transitory computer-readable storage medium comprising program code instructions which execute a AVM calibration method by use of generative artificial intelligence by a computer hardware device, the method comprising:
acquiring a camera image for an AVM video in a calibration facility space where markers are installed;
initializing a camera parameter (Z) for AVM video generation;
initially forming a marker candidate group by extracting a plurality of marker candidate images through outline-based image analysis of the camera image for each marker; and
performing full-automatic-mode AVM calibration based on marker outlines for the marker candidate group by use of the generative AI model,
wherein the performing full-automatic-mode AVM calibration includes:
performing, by a policy network, adjustment of a camera parameter (Z) and primary filtering on the marker candidate group by a multilayer perceptron (MLP) neural network with individual marker candidate images as references;
performing, by a value network, secondary filtering on the marker candidate group by a convolutional neural network (CNN) with marker candidate images (hereinafter referred to as ‘common marker candidate image’) overlapping each other in a common region of adjacent cameras as references; and
performing, by a control network, additional adjustment of the camera parameter (Z) based on a marker probability value for the marker candidate group by an MDN-RNN neural network.

9. A non-transitory computer program contained in a non-transitory computer-readable storage medium comprising program code instructions which execute a AVM calibration method by use of generative artificial intelligence by a computer hardware device, the method comprising:
acquiring a camera image for an AVM video in a calibration facility space where markers are installed;
initializing a camera parameter (Z) for AVM video generation;
initially forming a marker candidate group by extracting a plurality of marker candidate images through outline-based image analysis of the camera image for each marker; and
performing full-automatic-mode AVM calibration based on marker outlines for the marker candidate group by use of the generative AI model,
wherein the performing full-automatic-mode AVM calibration includes:
performing, by a policy network, adjustment of a camera parameter (Z) and primary filtering on the marker candidate group by a multilayer perceptron (MLP) neural network with individual marker candidate images as references;
performing, by a value network, secondary filtering on the marker candidate group by a convolutional neural network (CNN) with marker candidate images (hereinafter referred to as ‘common marker candidate image’) overlapping each other in a common region of adjacent cameras as references; and
performing, by a control network, additional adjustment of the camera parameter (Z) based on a marker probability value for the marker candidate group by an MDN-RNN neural network,
wherein the performing adjustment of a camera parameter (Z) and primary filtering on the marker candidate group includes:
receiving, by the policy network, a current camera parameter (Zₖ) and the marker candidate group;
transforming, by the policy network, individual marker candidate images (O_{c1}) belonging to the marker candidate group into images based on the current camera parameter (Zₖ);
extracting, by the policy network, a feature vector for each of the transformed marker candidate images (O_{c1}′);
calculating, by the policy network, a probability (r₁) (hereinafter referred to as an ‘individual marker probability value (r₁)’) that a corresponding marker candidate image (O_{c1}) is a marker image by inputting the feature vector into the MLP neural network;
performing, by the policy network, the primary filtering on the marker candidate group based on the individual marker probability value (r₁); and
calculating, by the policy network, an intermediate camera parameter (Zₖ₊₁) that optimally fits the marker candidate images to a standard marker shape for the marker candidate group obtained after the primary filtering,
wherein the performing secondary filtering on the marker candidate group includes:
receiving, by the value network, the intermediate camera parameter (Zₖ₊₁) and the marker candidate group obtained after the primary filtering;
applying, by the value network, the intermediate camera parameter (Zₖ₊₁) to the marker candidate images (O_{c1} and O_{c2}) overlapping each other in the common region of the adjacent cameras from the marker candidate group;
calculating, by the value network, a probability (r₂) (hereinafter referred to as ‘common marker probability value (r₂)’) that a synthetic marker candidate image (O_{c1|c2}) obtained by merging the transformed marker candidate images (O_{c1} and O_{c2}) is a marker image by inputting the synthetic marker candidate image (O_{c1|c2}) into the CNN neural network; and
performing, by the value network, secondary filtering on the marker candidate group based on the common marker probability value (r₂),
and wherein the performing additional adjustment of the camera parameter (Z) includes:
receiving, by the control network, the intermediate camera parameter (Zₖ₊₁), the individual marker probability value (r₁), and the common marker probability value (r₂);
calculating, by the control network, a probability density function (P(z)) by inputting the intermediate camera parameter (Zₖ₊₁), the individual marker probability value (r₁), and the common marker probability value (r₂) into a recurrent neural network (RNN); and
calculating, by the control network, an auto-adjustment camera parameter (Zₖ₊₂) by inputting the probability density function P(z) into a mixture density neural network (MDN).
